(19) United States
(12) Patent Application Publication
(10) Pub. No.: US 2017/0091453 A1
(43) Pub. Date: Mar. 30, 2017

(54) ENFORCEMENT OF FILE CHARACTERISTICS

(71) Applicant: McAfee, Inc., Santa Clara, CA (US)

(72) Inventor: Cedric Cochin, Portland, OR (US)

(73) Assignee: McAfee, Inc., Santa Clara, CA (US)

(21) Appl. No.: 14/866,765

(22) Filed: Sep. 25, 2015

(51) Int. Cl. G06F 21/56; G06F 21/64

(52) U.S. Cl. CPC G06F 21/565; G06F 21/64; G06F 2221/033

(57) ABSTRACT

Particular embodiments described herein provide for an electronic device that can be configured to determine a file characteristic for a characteristic of a file, determine that the file has been modified to create a new file, determine a new characteristic for the characteristic of the new file, and create a security event if the new file characteristic does not match the file characteristic.

### TECHNICAL FIELD

This disclosure relates in general to the field of information security, and more particularly, to enforcement of file characteristics.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for enforcement of file characteristics in accordance with an embodiment of the present disclosure;

FIG. 2 is a simplified flowchart illustrating potential operations that may be associated with the communication system in accordance with an embodiment;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ARM ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

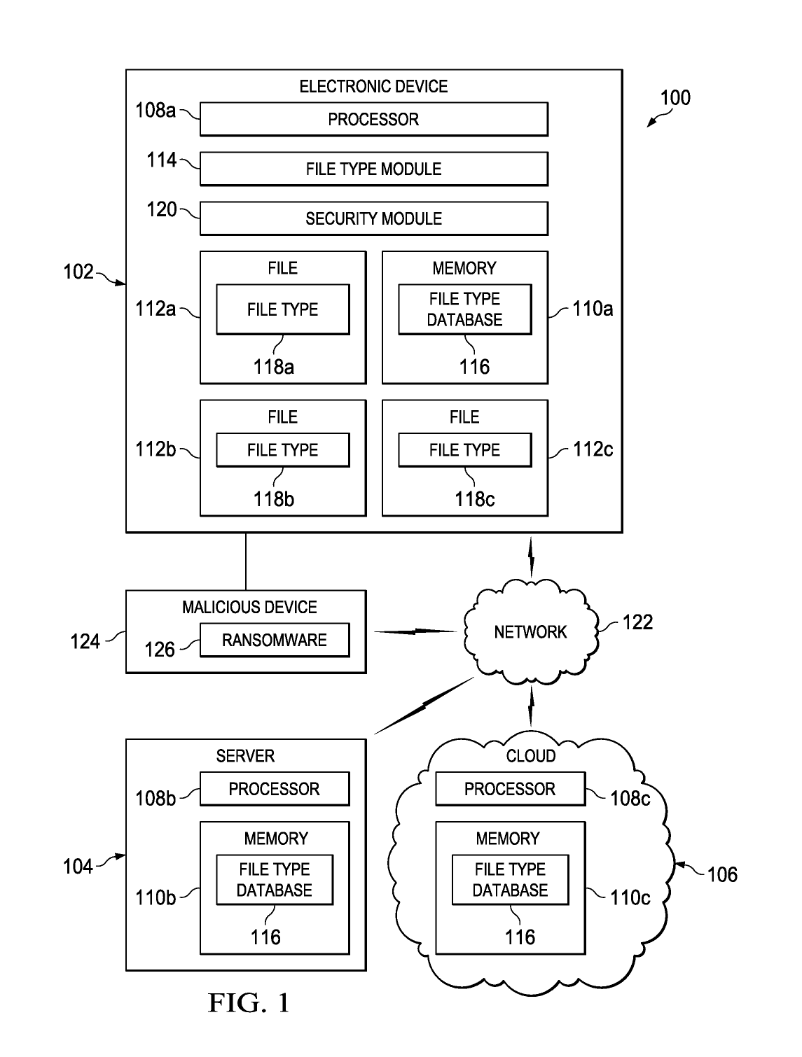

FIG. 1 is a simplified block diagram of a communication system 100 for file type enforcement of file characteristics in accordance with an embodiment of the present disclosure. As illustrated in FIG. 1, an embodiment of communication system 100 can include electronic device 102, a server 104, and a cloud 106. Electronic device 102 can include a processor 108a, memory 110a, one or more files 112a-112c, a file type module 114, and a security module 120. Memory can include a file type database 116. Each file 112a-112c can include a file type 118a-118c respectively. Server 104 can include a processor 108b and memory 110b. Memory 110b can include file type database 116. Cloud 106 can include a processor 108c and memory 110c. Memory 110c can include file type database 116. Electronic device 102, server 104, and cloud 106 may be in communication using network 122. In an example, malicious device 124 can attempt to infect electronic device 102 with ransomware 126.

In an example, communication system 100 can be configured to determine a file characteristic for a file (e.g., file type, attributes, metadata, etc.) and when the file is modified, analyze the file to determine if one or more of the file characteristics had changed. If the file characteristics had changed or a specific file characteristic, or a predefined group of characteristics, then the change may be an indication of malicious activity and a security event (e.g., scanning or otherwise analyzing the system for malware, not allowing the modification of the file, etc.) can be created. In a specific example, communication system 100 can be configured to determine a type for a file, determine that the file has been modified to create a new file, determine a new file type for the new file, and create a security event if the new file type does not match the file type. In an example, the security event can including analyzing or scanning the system for malware using security module 120. Also, communication system 100 can be configured to determine if the file was modified or created by a trusted application and if the file was not modified or created by a trusted application, then file type module 144 can analyze the file to determine the file type. The file type can be stored in a secure area of memory, for example, file type database 116 may be in a secured area of memory 110a. Before the file is created or modified, a backup of the file can be created and if the new file type does not match the (original) file type, then the modification is not allowed.

Elements of FIG. 1 may be coupled to one another through one or more interfaces employing any suitable connections (wired or wireless), which provide viable pathways for network (e.g., network 122) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Ransomware (e.g. ransomware 126) is a type of malware that restricts access to a computer system that it infects and demands a ransom paid to the creator(s) of the malware in order for the restriction to be removed. Some forms of ransomware encrypt files on the system's hard drive, while some may simply lock the system and display messages intended to coax the user into paying. Ransomware typically propagates as a trojan like a conventional computer worm, entering a system through, for example, a downloaded file or a vulnerability in a network service. The ransomware will then run a payload such as one that will begin to encrypt personal files on the hard drive. More sophisticated ransomware may hybrid-encrypt the victim's documents with a random symmetric key and a fixed public key. The malware author is the only party that knows the needed private decryption key. CryptoLocker is one of the most prevalent ransomware.

Current security solutions (e.g., antivirus solutions, malware detection systems, etc.) often do not address the problem of files encrypted by ransomware. While some security solutions may detect the ransomware itself, they have no direct mechanism to protect the files, especially documents that the ransomware may encrypt. Some security solutions may attempt to restore the encrypted files as part of their malware repair but this is not possible in the case of an encryption using a private key that is not stored on the infected endpoint.

Some aspect of ransomware can be addressed with current security solutions upon detection of the malicious file. Upon detection, some security solutions can trigger a repair process and remove any artefact of the ransomware, including the simple lock that prevented the proper usage of the computer. However when files have been encrypted and the private key needed for decryption is not present on the infected device, the security solution cannot restore the files that have been encrypted by the ransomware. As a result, the contents of files such as documents and images, (e.g., Microsoft® Office® files, images, PDFs, etc), are lost.

Whitelisting and application control solutions, while protecting executables and key operating system components, including configuration files, from malicious modifications, do not offer protection for content on the system. The content is either locked, preventing any modification to be made, or the access to the content is restricted to a list of whitelisted applications. Whitelisting and application control solutions, while partially successful in highly restricted enterprise environments are mostly not applicable on ever changing consumer devices. What is needed is a system and method to identify and protect against ransomware.

A communication system for file type enforcement, as outlined in FIG. 1 can resolve these issues (and others). Communication system 100 may be configured to store the file type of a file object as an external attribute and monitor all modifications made to the file to ensure that the modification doesn't result into a change of file type. By monitoring file and their associated file format and malicious and destructive changes to the file may be prevented. More specifically, communication system can be configured to prevent files from being modified by the ransomware in the first place.

A file format is a standard way that information is encoded for storage in a computer file. The file format specifies how bits are used to encode information in a digital storage medium. A typical approach to identify a file format is to use information regarding the format stored inside the file itself, either information meant for this purpose or binary strings that happen to always be in specific locations in files of some formats. File type module 114 can be configured to recognize files without external attributes and can include a file format recognition library to identify file types. Security module 120 can be configured to apply appropriate security rules.

Typically, when ransomware encrypts files, it do not maintain the original file format. For example, a proper JPG file, after encryption by the ransomware, will not be a JPG file anymore, but an encrypted blob of data that file format libraries would either identify as encrypted data or fail to recognize. Security module 120 can be configured to monitor file events and when a protected file is accessed, a quarantine copy of the file can be made. If the file is modified, upon completion of the modification, the file format can be identified by file type module 114. If the resulting file format is identical to or the same as the stored file format, the modification is approved. However, if the resulting file format is different than the stored file format, the modification is flagged and reverted to the original file format using the quarantine copy of the file. The flagged modification can be used to alert a security module that malicious activity may have taken place and the system can be analyzed for malware.

Turning to the infrastructure of FIG. 1, communication system 100 in accordance with an example embodiment is shown. Generally, communication system 100 can be implemented in any type or topology of networks. Network 122 represents a series of points or nodes of interconnected communication paths for receiving and transmitting packets of information that propagate through communication system 100. Network 122 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 102, server 104, and cloud 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 102, server 104, and cloud 106 can include memory elements (e.g., memory 110a-110c) for storing information to be used in the operations outlined herein. Each of electronic device 102, server 104, and cloud 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 102, server 104, and cloud 106 may include software modules (e.g., file type module 114 and security module 120) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 102, server 104, and cloud 106 may include a processor (e.g., processor 108a-108c) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 102 can be a network element and include, for example, desktop computers, laptop computers, mobile devices, personal digital assistants, smartphones, tablets, or other similar devices. Server 104 can be a network element such as a server or virtual server and can be associated with clients, customers, endpoints, or end users wishing to initiate a communication in communication system 100 via some network (e.g., network 122). The term ‘server’ is inclusive of devices used to serve the requests of clients and/or perform some computational task on behalf of clients within communication system 100. Although file type module 114 and security module 120 are represented in FIG. 1 as being located in electronic device 102, this is for illustrative purposes only. File type module 114 and security module 120 could be combined or separated in any suitable configuration. Furthermore, file type module 114 and security module 120 could be integrated with or distributed in another network accessible by electronic device 102. Cloud 106 is configured to provide cloud services to electronic device 102. Cloud services may generally be defined as the use of computing resources that are delivered as a service over a network, such as the Internet. Typically, compute, storage, and network resources are offered in a cloud infrastructure, effectively shifting the workload from a local network to the cloud network.

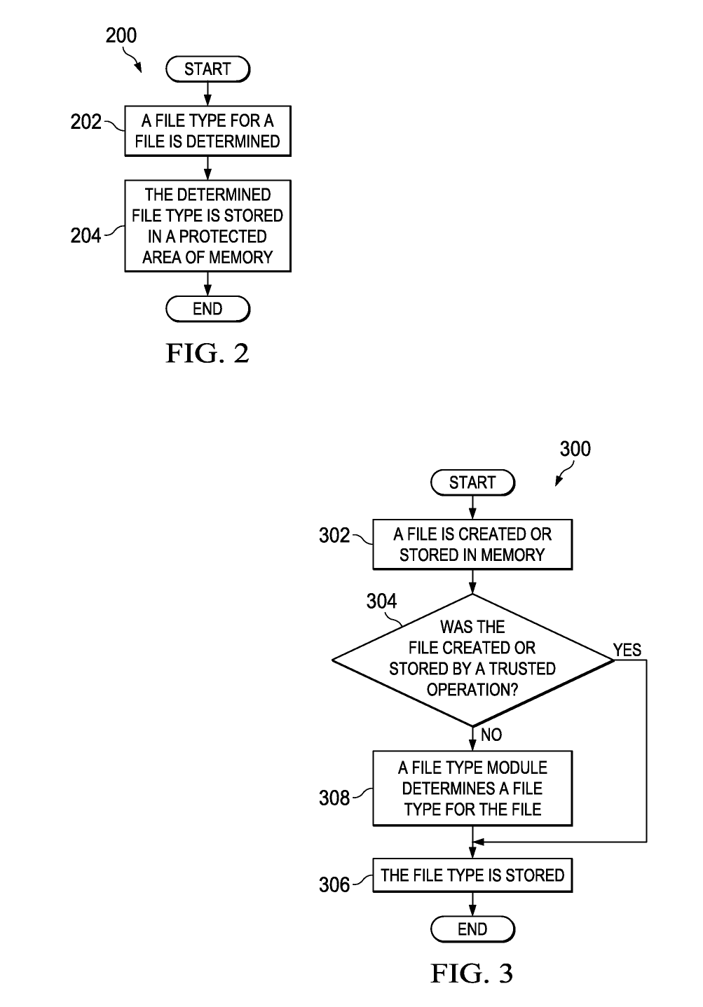

Turning to FIG. 2, FIG. 2 is an example flowchart illustrating possible operations of a flow 200 that may be associated with file type enforcement, in accordance with an embodiment. In an embodiment, one or more operations of flow 200 may be performed by file type module 114 and security module 120. At 202, a file type for a file is determined. For example, file type module 114 may determine file type 118a for file 112a. At 204, the determined file type is stored in a protected area of memory. For example, file type 118a for file 112a may be stored in file type database 116, in electronic device 102, server 104, and/or cloud 108.

Turning to FIG. 3, FIG. 3 is an example flowchart illustrating possible operations of a flow 300 that may be associated with file type enforcement, in accordance with an embodiment. In an embodiment, one or more operations of flow 300 may be performed by file type module 114 and security module 120. At 302 a file is created or stored in memory. At 304, the system determines if the file was created or stored by a trusted operation. For example, security module 120 may determine whether or not the file was created by a trusted application. The trusted operation may be from a trusted program or process. If the file was created by a trusted operation, then the file type is stored, as in 306. If the file was not created or stored by a trusted operation, then a file type module (e.g., file type module 114) determines a file type of the file, as in 308. If the operation is not a trusted operation, then the operation may be malicious and could be attempting to mask or hide the file type. At 306, the file type is stored.

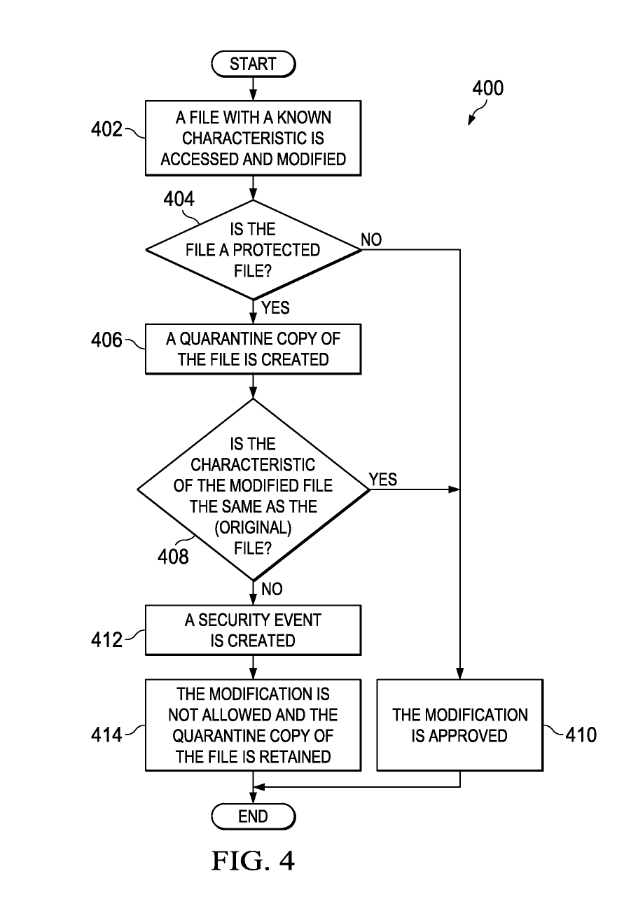

Turning to FIG. 4, FIG. 4 is an example flowchart illustrating possible operations of a flow 400 that may be associated with file type enforcement, in accordance with an embodiment. In an embodiment, one or more operations of flow 400 may be performed by file type module 114 and security module 120. At 402, a file is accessed and modified. At 404, the system determines if the file is a protected file. If the file is not a protected file, then the modification is approved, as in 410. If the file is a protected file, then a quarantine copy of the file is created, as in 406. At 408, the system determines if the format of type of the modified file is the same as the (original) file. If the format or type of the modified file is the same as the (original) file, then the modification is approved. If the format or type of the modified file is not the same as the (original) file, then a security event is created as in 412. At 414, the modification is not allowed and the quarantine copy of the file is retained. If ransomware attempts to modify a file and changes the file format, then the system can determine that the modified file is not the same file type as the original file and security module can analyze the system for malware.

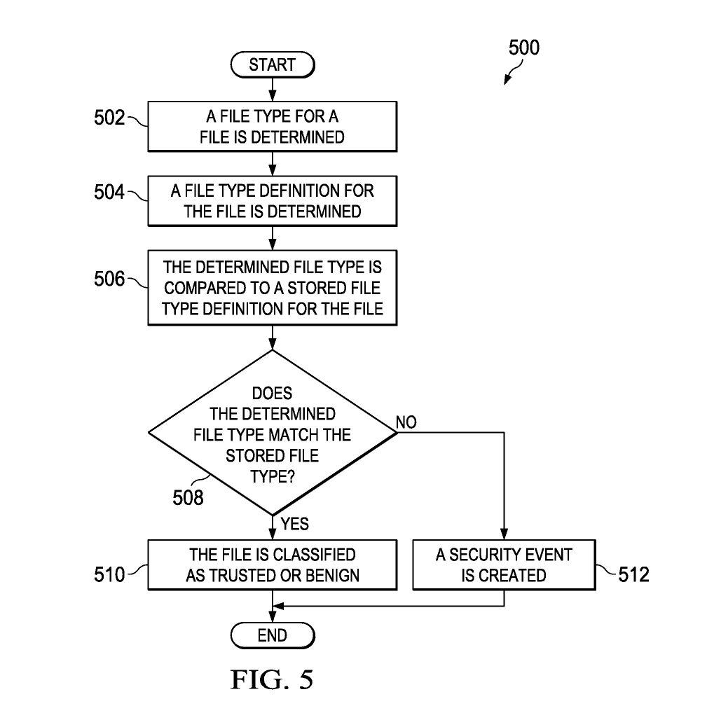

Turning to FIG. 5, FIG. 5 is an example flowchart illustrating possible operations of a flow 500 that may be associated with file type enforcement, in accordance with an embodiment. In an embodiment, one or more operations of flow 500 may be performed by file type module 114 and security module 120. At 502 a file type for a file is determined. For example, the extension of the file may be used to determine the file type. At 504, a file type definition for the file is determined. For example, the file may be analyzed by file type module 114 to determine the file type. At 506, the determined file type is compared to a stored file type definition for the file. At 508, the system determines if the file type matches the stored file type. If the file type matches the stored file type, then the file is classified as trusted or benign, as in 510. If the file type does not match the stored file type, then a security event is crated, as in 512.

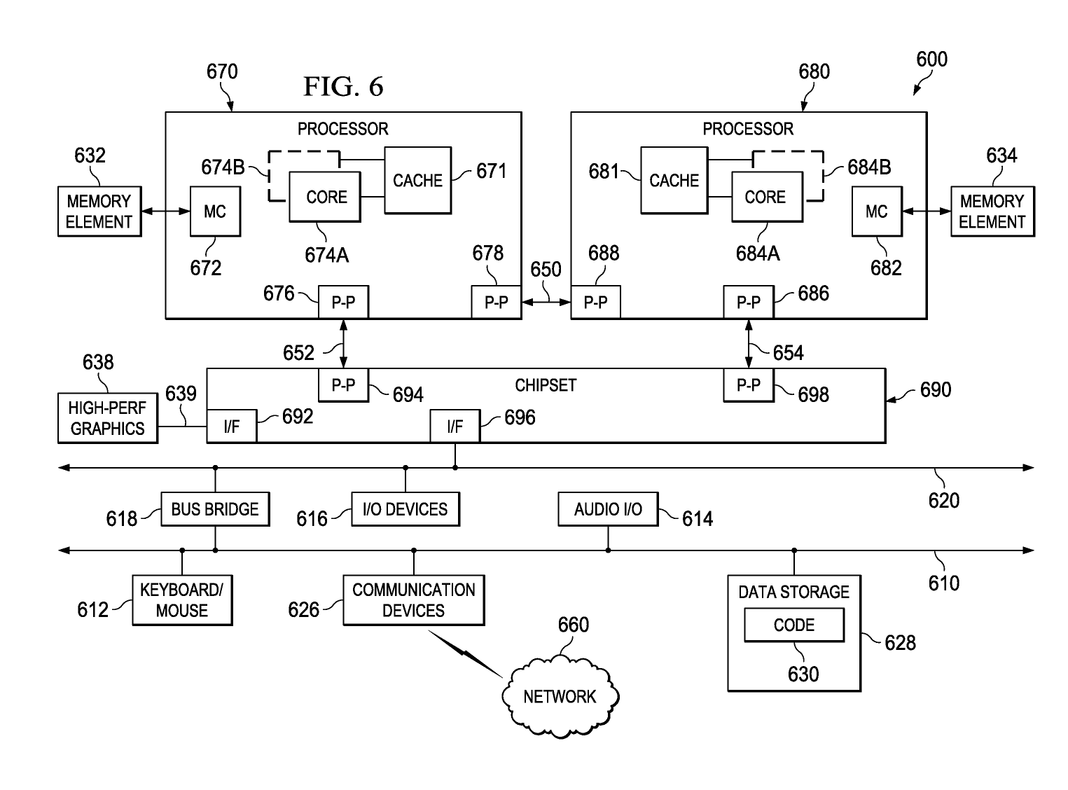

Turning to FIG. 6, FIG. 6 illustrates a computing system 600 that is arranged in a point-to-point (PtP) configuration according to an embodiment. In particular, FIG. 6 shows a system where processors, memory, and input/output devices are interconnected by a number of point-to-point interfaces. Generally, one or more of the network elements of communication system 100 may be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 1-5. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discreet logic separate from processors 670 and 680.

Processors 670 and 680 may be any type of processor and may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

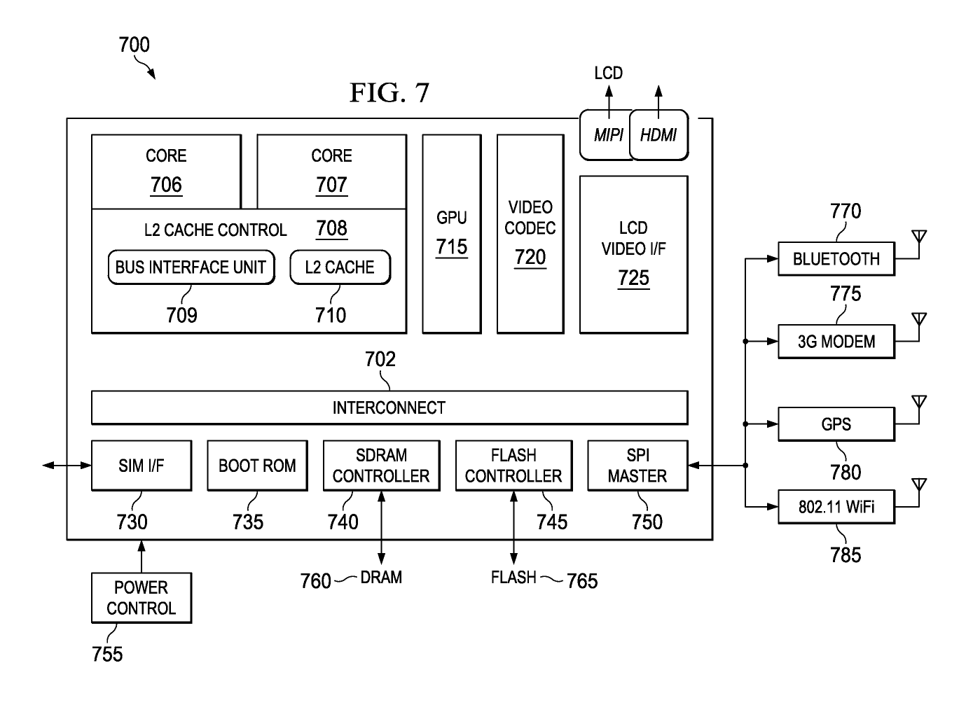

Turning to FIG. 7, FIG. 7 is a simplified block diagram associated with an example ARM ecosystem SOC 700 of the present disclosure. At least one example implementation of the present disclosure can include the detection of malicious strings features discussed herein and an ARM component. For example, the example of FIG. 7 can be associated with any ARM core (e.g., A-7, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more example embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

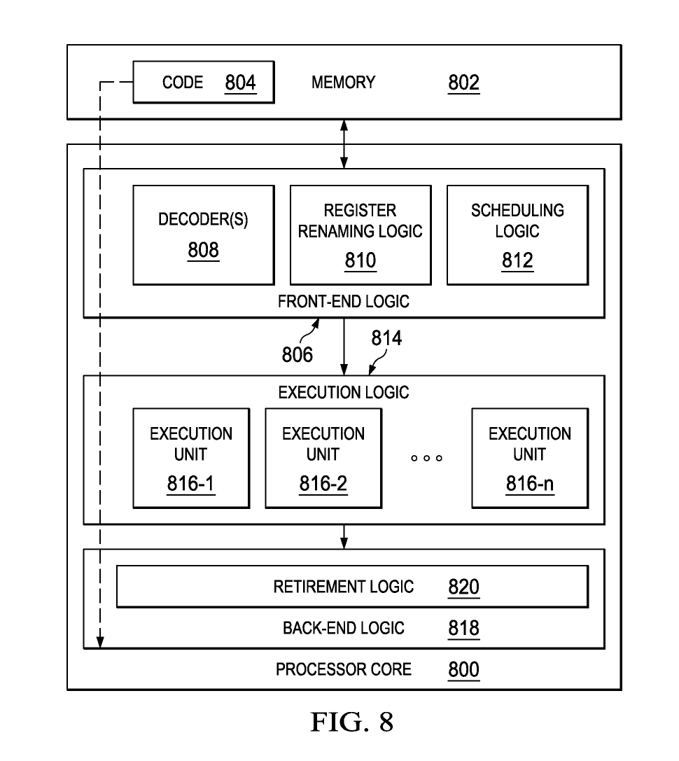

Turning to FIG. 8, FIG. 8 illustrates a processor core 800 according to an embodiment. Processor core 800 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents one example embodiment of processors cores 674a, 674b, 684a, and 684b shown and described with reference to processors 670 and 680 of FIG. 6. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 6. For example, as shown in FIG. 6, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagrams (i.e., FIGS. 3-5) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that when executed by at least one processor, cause the at least one processor to determine a file characteristic for a characteristic of a file, determine that the file has been modified to create a new file, determine a new characteristic for the characteristic of the new file, and create a security event if the new characteristic does not match the file characteristic.

In Example C2, the subject matter of Example C1 can optionally include where the file characteristic is a file type associated with the file.

In Example C3, the subject matter of any one of Examples C1-C2 can optionally include where the one or more instructions that when executed by the at least one processor, further cause the processor to determine the file type using a file type module if the file was not modified by a trusted application.

In Example C4, the subject matter of any one of Examples C1-C3 can optionally include where the security event includes analyzing a system that includes the file for malware.

In Example C5, the subject matter of any one of Examples C1-C4 can optionally include where the file characteristic is stored in a protected area of memory.

In Example C6, the subject matter of any one of Example C1-C5 can optionally include where the one or more instructions that when executed by the at least one processor, further cause the processor to create a copy of the file before the file is been modified to create the new file.

In Example A1, an electronic device can include a file type module, where the file type module is configured to determine a file characteristic for a characteristic of a file, determine that the file has been modified to create a new file, determine a new characteristic for the characteristic of the new file, and create a security event if the new characteristic does not match the file characteristic.

In Example, A2, the subject matter of Example A1 can optionally include where the file characteristic is a file type associated with the file.

In Example A3, the subject matter of any one of Examples A1-A2 can optionally include where the file characteristic is stored in a protected area of memory.

In Example A4, the subject matter of any one of Examples A1-A3 can optionally include a security module, where the security module is configured to receive the created security event and scan a system that includes the file for malware.

In Example A5, the subject matter of any one of Examples A1-A4 can optionally include where the security module is further configured to create a copy of the file before the file is been modified to create the new file.

Example M1 is a method including determining a file characteristic for a characteristic of a file, determining that the file has been modified to create a new file, determining a new characteristic for the characteristic of the new file, and creating a security event if the new characteristic does not match the file characteristic.

In Example M2, the subject matter of Example M1 can optionally include where the file characteristic is a file type associated with the file.

In Example M3, the subject matter of any one of the Examples M1-M2 can optionally include determining the new characteristic is performed by a file type module if the file was not modified by a trusted application.

In Example M4, the subject matter of any one of the Examples M1-M3 can optionally include where the file type is stored in a protected area of memory.

In Example M5, the subject matter of any one of the Examples M1-M4 can optionally include analyzing a system that includes the file for malware.

Example S1 is a system for enforcement of file characteristics, the system including a file type module configured for determining a file characteristic for a characteristic of a file, determining that the file has been modified to create a new file, determining a new characteristic for the characteristic of the new file, and creating a security event if the new characteristic does not match the file characteristic.

In Example S2, the subject matter of Example S1 can optionally include where the file characteristic is a file type associated with the file.

In Example S3, the subject matter of any one of the Examples S1-S2 can optionally include where the file characteristic is stored in a protected area of memory.

In Example S4, the subject matter of any one of the Examples S1-S3 can optionally include a security module configured for receiving the created security event and analyzing a system that includes the file for malware.

In Example S5, the subject matter of any one of the Examples S1-S4 can optionally include where the security module configured for creating a copy of the file before the file is been modified to create a new file.

Example SS1 is a system for enforcement of file characteristics, the system including means for determining a file characteristic for a characteristic of a file, means for determining that the file has been modified to create a new file, means for determining a new characteristic for the characteristic of the new file, and means for creating a security event if the new characteristic does not match the file characteristic.

In Example SS2, the subject matter of Example SS1 can optionally include where the file characteristic is a file type associated with the file.

In Example SS3, the subject matter of any one of the Examples SS1-SS2 can optionally include where the file characteristic is stored in a protected area of memory.

In Example SS4, the subject matter of any one of the Examples SS1-SS3 can optionally include means for receiving the created security event and analyzing a system that includes the file for malware.

In Example SS5, the subject matter of any one of the Examples SS1-SS4 can optionally include where means for creating a copy of the file before the file is been modified to create a new file.

Example X1 is a machine-readable storage medium including machine-readable instructions to implement a method or realize an apparatus as in any one of the Examples A1-A5, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one computer-readable medium comprising one or more instructions that when executed by at least one processor, cause the at least one processor to:
determine a file characteristic for a characteristic of a file;
determine that the file has been modified to create a new file;
determine a new characteristic for the characteristic of the new file; and
create a security event if the new characteristic does not match the file characteristic.

2. The at least one computer-readable medium of claim 1, wherein the characteristic is a file type associated with the file.

3. The at least one computer-readable medium of claim 2, wherein the new characteristic is determined using a file type module if the file was not modified by a trusted application.

4. The at least one computer-readable medium of claim 1, wherein the security event includes analyzing a system that includes the file for malware.

5. The at least one computer-readable medium of claim 1, wherein the file characteristic is stored in a protected area of memory.

6. The at least one computer-readable medium of claim 1, further comprising one or more instructions that when executed by the at least one processor, further cause the processor to:
create a copy of the file before the file is been modified to create the new file.

7. An apparatus comprising:
a file type module configured to:
determine a file characteristic for a characteristic of a file;
determine that the file has been modified to create a new file;
determine a new characteristic for the characteristic of the new file; and
create a security event if the new characteristic does not match the file characteristic.

8. The apparatus of claim 7, wherein the characteristic is a file type associated with the file.

9. The apparatus of claim 7, wherein the file characteristic is stored in a protected area of memory.

10. The apparatus of claim 7, further comprising:
a security module configured to:
receive the created security event; and
analyze a system that includes the file for malware.

11. The apparatus of claim 10, wherein the security module is further configured to:
create a copy of the file before the file is been modified to create the new file.

12. A method comprising:
determining a file characteristic for a characteristic of a file;
determining that the file has been modified to create a new file;
determining a new characteristic for the characteristic of the new file; and
creating a security event if the new characteristic does not match the file characteristic.

13. The method of claim 12, wherein the characteristic is a file type associated with the file.

14. The method of claim 13, wherein determining the new characteristic is performed by a file type module if the file was not modified by a trusted application.

15. The method of claim 12, wherein the file characteristic is stored in a protected area of memory.

16. The method of claim 12, further comprising:
creating a copy of the file before the file is been modified to create a new file.

17. The method of claim 12, further comprising:
analyzing a system that includes the file for malware.

18. A system for enforcement of file characteristics, the system comprising:
a file type module configured for:
determining a file characteristic for a characteristic of a file;
determining that the file has been modified to create a new file;
determining a new characteristic for the characteristic of the new file; and
creating a security event if the new characteristic does not match the file characteristic.

19. The system of claim 18, wherein the characteristic is a file type associated with the file.

20. The system of claim 18, wherein the file characteristic is stored in a protected area of memory.
